(19) United States
(12) Patent Application Publication
(10) Pub. No.: US 2021/0388803 A1
(43) Pub. Date: Dec. 16, 2021

(54) STARTING DEVICE AND STARTING SYSTEM OF VEHICLE

(71) Applicant: Shenzhen Crazy Monkey Technology Co., Ltd., Shenzhen (CN)

(72) Inventor: Boyu DU, Shenzhen (CN)

(21) Appl. No.: 17/221,527

(22) Filed: Apr. 2, 2021

(30) Foreign Application Priority Data
Jun. 12, 2020 (CN) 202010539928.2
Jun. 12, 2020 (CN) 202021090879.0

(51) Int. Cl. F02N 11/08

(52) U.S. Cl. CPC F02N 11/0862; F02N 2200/061; F02N 11/087

(57) ABSTRACT

Disclosed are a starting device and a starting system of a vehicle. The starting device includes a first connection line, a second connection line and a starting module. The first connecting line and the second connecting line are configured to transmit a current provided by a starting power source to provide a voltage of the starting power source to a vehicle; the starting module is connected to at least one of the first connection line and the second connection line; the starting module is turned on when the first connection line and the second connection line are not connected to a vehicle battery of the vehicle; and the starting module is turned off, when the vehicle battery of the vehicle is charged and the first connection line and the second connection line are abnormally connected to the vehicle battery of the vehicle.

### CROSS-REFERENCE TO RELATED APPLICATIONS

This application claims priority to Chinese Application Nos. 202010539928.2 and 202021090879.0, both filed on Jun. 12, 2020, the entire disclosure of which are incorporated herein by reference.

### TECHNICAL FIELD

The present disclosure relates to the technical field of vehicles, in particular to a starting device and a starting system of a vehicle.

### BACKGROUND

Nowadays, most of the vehicles use the starting power source to start. A relay or a MOS tube is connected between the starting power source and the wiring clamp of the vehicle battery to prevent a short circuit between the starting power source and the vehicle battery and damaging the starting power source. Since the relay or MOS tube needs the vehicle battery of the vehicle to provide voltage before it can be started, if the user connects the positive and negative electrodes of the starting power source to the positive and negative electrodes of the vehicle battery correctly, the vehicle battery can provide voltage to the relay or MOS tube, so that the starting power source can supply power to the vehicle and the vehicle can be started normally. If the user connects the positive and negative electrodes of the starting power source to the positive and negative electrodes of the vehicle battery reversely or the vehicle battery is out of power or damaged, the vehicle battery cannot provide voltage to the relay or MOS tube, and the starting power source cannot supply power to the vehicle, and the vehicle cannot start. The existing starting power source and the relay or MOS tube on the wiring clamp of the vehicle battery need the vehicle battery of the vehicle to provide voltage before it can be started. Therefore, the use of the existing wiring clamp can only assist the vehicle to start when the vehicle battery is charged, but cannot assist the vehicle start when the vehicle battery is out of power or damaged.

### SUMMARY

The present disclosure provides a starting device, which aims to protect the starting power source when the user mistakenly connects the positive and negative electrodes of the starting power source to the vehicle, and can still provide voltage to the vehicle when the vehicle battery is out of power or damaged, and assist the vehicle to start.

In order to achieve the above objective, the present disclosure provides a starting device, including a first connection line, a second connection line and a starting module;

the first connecting line and the second connecting line are configured to transmit a current provided by a starting power source to provide a voltage of the starting power source to a vehicle;

the starting module is connected to at least one of the first connection line and the second connection line, the starting module is turned on when the first connection line and the second connection line are not connected to a vehicle battery of the vehicle, and the starting module is turned off when the vehicle battery of the vehicle is charged and the first connection line and the second connection line are abnormally connected to the vehicle battery of the vehicle.

In this embodiment, the starting module can be turned off when the vehicle battery of the vehicle is charged and the first connection line and the second connection line are abnormally connected to the vehicle battery of the vehicle. In this way, it is avoided that the user mistakenly connects the positive and negative electrodes of the first connection line and the second connection line to the vehicle and damages the starting power source, thereby protecting the starting power source. In addition, when the first connection line and the second connection line are not connected to the vehicle, and are turned on, so that the starting module does not need to be supplied with voltage from the vehicle battery of the vehicle. That is, when the battery of the vehicle is damaged or has no electricity at all, it can also be turned on, so that the voltage of the starting power source is directly provided to the vehicle when it is normally connected to the vehicle battery of the vehicle, which overcomes the problem that relays and MOS tubes need to be powered by the vehicle battery of the vehicle before they can be started.

In an embodiment, the starting module is also turned on when the first connection line and the second connection line are normally connected to the vehicle battery of the vehicle.

In this embodiment, the starting module is turned on when the first connection line and the second connection line are normally connected to the vehicle battery of the vehicle (that is, the user correctly connects the positive and negative electrodes of the first connection line and the second connection line to the vehicle battery of the vehicle), which enables the voltage of the starting power source to be supplied to the vehicle to assist the vehicle normally start.

In an embodiment, the starting module at least includes a first electromagnet, a second electromagnet and an electromagnetic coil;

the first connection line includes a first portion of the first connection line and a second portion of the first connection line, and a first contact and a second contact are respectively provided at a junction of the first portion and the second portion;

the electromagnetic coil is fixedly sleeved on the first electromagnet, a first end of the electromagnetic coil is connected to the vehicle battery of the vehicle via the second portion of the first connection line, and a second end of the electromagnetic coil is connected to the second connection line; and

the first electromagnet and the second electromagnet repel each other to be turned off when the vehicle battery of the vehicle is charged and the first connection line and the second connection line are abnormally connected to the vehicle battery of the vehicle.

In this embodiment, when the vehicle battery of the vehicle is charged and the first connection line and the second connection line are abnormally connected to the vehicle (that is, when the user mistakenly connects the positive and negative electrodes of the first connection line and the second connection line to the vehicle battery of the vehicle), a reverse current will flow to the electromagnetic coil, and the electromagnetic coil will generate an induced magnetic field. According to the principle of repulsion of the same polarity, the first electromagnet and the second electromagnet repel each other and are turned off. The starting device of the present disclosure can avoid the problem that the user mistakenly connects the positive and negative electrodes of the first connection line and the second connection line to the vehicle to damage the starting power source and the starting device, thereby protecting the starting power source and the starting device.

In an embodiment, the first electromagnet is attracted to the second electromagnet to turn on the starting module when the first connection line and the second connection line are not connected to the vehicle battery of the vehicle, or

the first electromagnet is attracted to the second electromagnet to turn on the starting module and the voltage of the starting power source is provided to the vehicle when the first connection line and the second connection line are normally connected to the vehicle battery of the vehicle.

In an embodiment, the first electromagnet is attracted to the second electromagnet to turn on the starting module includes:

the second electromagnet is attracted to contact with the first contact and the second contact, so that the starting module is turned on.

In this embodiment, the second electromagnet is attracted to contact with the first contact and the second contact, so that the starting module is turned on, and the starting device forms a path to allow current to flow.

In an embodiment, the first electromagnet is an electromagnet, and the second electromagnet is a permanent magnet.

In an embodiment, the starting device further includes a housing; the starting module is received in housing, at least one through hole is provided on the housing, and the first connection line and/or the second connection line are configured to pass through the at least one through hole.

In order to achieve the above objective, the present disclosure further provides a starting system of a vehicle. The starting system of the vehicle includes the starting device described in any one of the above embodiments and a starting power source connected to the starting device.

In order to achieve the above objective, the present disclosure further provides a vehicle, the vehicle including: the starting device described in any of the above embodiments.

In order to achieve the above objective, the present disclosure further provides a vehicle, the vehicle including: the starting system of the vehicle described in any of the above embodiments.

### BRIEF DESCRIPTION OF THE DRAWINGS

In order to more clearly illustrate the embodiments of the present disclosure, drawings used in the embodiments will be briefly described below. Obviously, the drawings in the following description are only some embodiments of the present disclosure. It will be apparent to those skilled in the art that other figures can be obtained according to the structures shown in the drawings without creative work.

FIG. 1 shows a schematic diagram of application of a starting device according to an embodiment of the present disclosure.

FIG. 2 shows a schematic structural diagram of the starting device according to an embodiment of the present disclosure.

FIG. 3 shows a schematic structural diagram of a starting module according to an embodiment of the present disclosure.

FIG. 4 shows a schematic structural diagram of a housing containing the starting module according to an embodiment of the present disclosure.

The realization of the objective, functional characteristics, and advantages of the present disclosure are further described with reference to the accompanying drawings.

### DETAILED DESCRIPTION OF THE EMBODIMENTS

The technical solutions of the embodiments of the present disclosure will be described in more detail below with reference to the accompanying drawings. It is obvious that the embodiments to be described are only some rather than all of the embodiments of the present disclosure. All other embodiments obtained by persons skilled in the art based on the embodiments of the present disclosure without creative efforts shall fall within the scope of the present disclosure.

It should be noted that if there is a directional indication (such as up, down, left, right, front, rear . . . ) in the embodiments of the present disclosure, the directional indication is only used to explain the relative positional relationship, movement, etc. of the components in a certain posture (as shown in the drawings). If the specific posture changes, the directional indication will change accordingly.

Besides, the descriptions associated with, e.g., “second” and “third,” in the present disclosure are merely for descriptive purposes, and cannot be understood as indicating or suggesting relative importance or impliedly indicating the number of the indicated technical feature. Therefore, the feature associated with “second” or “third” can expressly or impliedly include at least one such feature. In addition, the technical solutions between the various embodiments can be combined with each other, but they must be based on the realization of those of ordinary skill in the art. When the combination of technical solutions is contradictory or cannot be achieved, it should be considered that such a combination of technical solutions does not exist, nor is it within the scope of the present disclosure.

At present, a relay or a MOS tube is usually used to identify whether the user mistakenly connects the positive and negative electrodes of the starting power supply to the vehicle. The relay or MOS tube can protect the circuit when the user mistakenly connects the positive and negative electrodes of the starting power supply to the vehicle. However, at least the following two problems cannot be identified through the relay or MOS tube. 1) Since the activation of the relay or MOS tube depends on the power provided by the vehicle battery, if the vehicle battery is damaged or has no electricity at all, it will not be able to provide voltage to the relay or MOS tube, causing the relay or MOS tube to fail to start, thus making it impossible for the vehicle to start. 2) For vehicles or diesel vehicles with large displacements, they require considerable starting current, and the starting current (for example more than 2000 A) exceed the carrying range of the relay or MOS tube, which will cause electric shock or damage to the relay or MOS tube. For example, an instantaneous current exceeding 2000 A often breaks down a single MOS tube, which causes an avalanche effect and damages other MOD tubes as well. Therefore, when the vehicle battery is damaged or has no electricity at all, or the vehicle to be started requires a considerable starting current, neither the relay nor the MOS tube can be started. As a result, the starting power source cannot supply power to the vehicle and the vehicle cannot start. In addition, due to the large volume of the relay and MOS tube, the volume of the starting device is also large. Therefore, there is a need to provide a starting device that can solve any of the above problems.

The present disclosure provides a starting device 10.

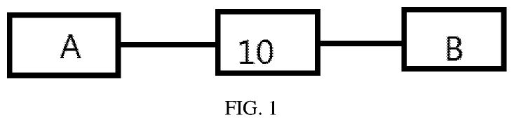

FIG. 1 shows a schematic diagram of application of a starting device 10 according to an embodiment of the present disclosure.

As shown in FIG. 1, the starting device 10 of the present disclosure may be applied between a vehicle battery B of a vehicle and a starting power source A. The starting device 10 is used to safely provide a voltage of the starting power source A to the vehicle when the vehicle battery B of the vehicle is out of power, or damaged, or the vehicle needs a considerable starting current (for example: a starting current of 300 A-3000 A is required), so as to assist the vehicle start normally.

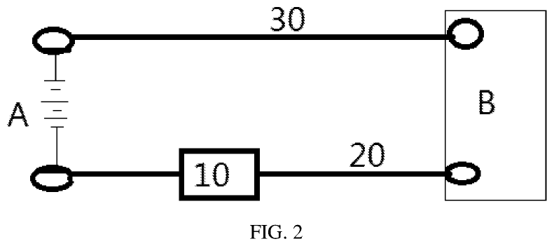

FIG. 2 shows a schematic structural diagram of the starting device 10 according to an embodiment of the present disclosure.

As shown in FIG. 2, the starting device 10 at least includes a first connection line 20, a second connection line 30 and a starting module 40. The first connecting line 20 and the second connecting line 30 can transmit a current provided by the starting power source A to provide a voltage of the starting power source A to a vehicle. The starting module 40 is connected to at least one of the first connection line 20 and the second connection line 30 (for example: FIG. 2 only shows that the starting module 40 is connected to the first connecting line 20). The starting module 40 can be turned on (for example, adsorption) when the first connection line 20 and the second connection line 30 are not connected to the vehicle battery B of the vehicle, and the starting module 40 is turned off when the vehicle battery B of the vehicle is charged and the first connection line 20 and the second connection line 30 are abnormally connected to the vehicle battery B of the vehicle.

It should be noted that the starting module 40 can be turned off when the vehicle battery B of the vehicle is charged and the first connection line 20 and the second connection line 30 are abnormally connected to the vehicle battery B of the vehicle (that is, the first connection line 20 and the second connection line 30 are mistakenly connected by a user to the positive and negative electrodes of the vehicle battery B of the vehicle). After the starting module 40 is turned off, there is no current in the circuit composed of the starting power source A, the starting device 10 and the vehicle battery, which avoids that the positive and negative electrodes of the first connection line 20 and the second connection line 30 are mistakenly connected by the user to the vehicle battery B of the vehicle and damages the starting power source A and the starting device 10, thus protecting the starting power source A and the starting device 10.

Besides, when the first connection line 20 and the second connection line 30 are not connected to the vehicle battery B of the vehicle (that is, the starting device 10 is not working), the starting device 10 is also turned on. The starting module 40 does not need to be powered by the vehicle battery B of the vehicle, that is, when the vehicle battery B of the vehicle is damaged or has no electricity at all, it can also be turned on. Therefore, when it is normally connected to the vehicle battery B of the vehicle, the voltage of the starting power source A is directly provided to the vehicle, which overcomes the problem that the relay or MOS tube need to be powered by the vehicle battery B of the vehicle before starting.

In an embodiment, the starting module 40 is also turned on when the first connection line 20 and the second connection line 30 are normally connected to the vehicle battery B of the vehicle.

It can be understood that the starting module 40 is turned on when the first connection line and the second connection line are normally connected to the vehicle (that is, the positive and negative electrodes of the first connection line and the second connection line are correctly connected to the vehicle by the user), so that the voltage of the starting power source A can be supplied to the vehicle normally to assist the vehicle to start.

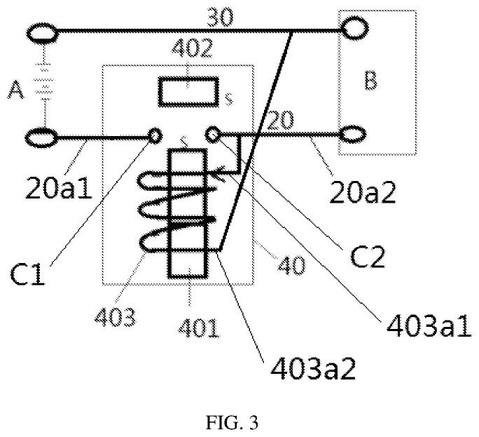

FIG. 3 shows a schematic structural diagram of a starting module 40 according to an embodiment of the present disclosure.

As shown in FIG. 3, the starting module 40 at least includes a first electromagnet 401, a second electromagnet 402 and an electromagnetic coil 403.

The first connection line 20 includes a first portion 20a1 and a second portion 20a2, and a first contact C1 and a second contact C2 are respectively provided at junctions of the first portion and 20a1 the second portion 20a2.

The electromagnetic coil 403 is fixedly sleeved on the first electromagnet 401, a first end 403a1 of the electromagnetic coil 403 is connected to the vehicle battery B of the vehicle via the second portion 20a2 of the first connection line, and a second end 403a2 of the electromagnetic coil is connected to the second connection line 30.

The first electromagnet 401 and the second electromagnet 402 repel each other to be turned off when the vehicle battery B of the vehicle is charged and the first connection line 20 and the second connection line 30 are abnormally connected to the vehicle battery B of the vehicle. In the present disclosure, the first electromagnet 401 is an electromagnet, and the second electromagnet 402 is a permanent magnet.

Specially, when the vehicle battery B of the vehicle is charged and the positive and negative electrodes of the first connection line 20 and the second connection line 30 are mistakenly connected to the vehicle battery B of the vehicle by the user, as indicated by the arrow in FIG. 3, current flows through the electromagnetic coil 403, and the electromagnetic coil 403 generates an induced magnetic field. Since the magnetic field generated by the electromagnetic coil 403 is opposed to the second electromagnet 402 (for example, the S pole direction of the magnetic field generated by the electromagnetic coil 403 is opposed to the magnetic S pole of the second electromagnet 402), according to the principle of repulsion of the same polarity, the first electromagnet 401 and the second electromagnet 402 repel each other and are turned off. The starting device 10 of the present disclosure can prevent the positive and negative electrodes of the first connection line 20 and the second connection line 30 from being incorrectly connected to the vehicle battery B of the vehicle by the user and damaging the starting power source A and the starting device 10, thus protecting the starting power source A and the starting device 10. In addition, the starting module 40 does not need to be supplied with voltage from the vehicle battery B of the vehicle, that is, it can be turned on when the vehicle battery B of the vehicle is damaged or has no electricity at all. Therefore, when it is normally connected to the vehicle battery B of the vehicle, the voltage of the starting power source A is directly provided to the vehicle, which overcomes the problem that the relay or MOS tube need to be powered by the vehicle battery B of the vehicle before starting.

In an embodiment, the first electromagnet 401 is attracted to the second electromagnet 402 to turn on the starting module when the first connection line 20 and the second connection line 30 are not connected to the vehicle battery B of the vehicle, or

the first electromagnet 401 is attracted to the second electromagnet 402 to turn on the starting module 40 and the voltage of the starting power source A is provided to the vehicle when the first connection line 20 and the second connection line 30 are normally connected to the vehicle battery B of the vehicle.

It should be understood that when the first connection line 20 and the second connection line 30 are not connected to the vehicle battery B of the vehicle, that is, when the vehicle battery B of the vehicle does not provide voltage or no other external power sources provide voltage, the second electromagnet 402 is attracted to the first electromagnet 401 by its own magnetic force, thereby making the first contact C1 and the second contact C2 being connected. As such, the starting module 40 does not require the vehicle battery B of the vehicle to provide voltage, that is, it can be turned on when the vehicle battery is damaged or has no electricity at all. Therefore, when connected to the vehicle, the voltage of the starting power source A is directly and normally provided to the vehicle, which overcomes the problem that the relay or MOS tube need to be powered by the vehicle battery of the vehicle before starting.

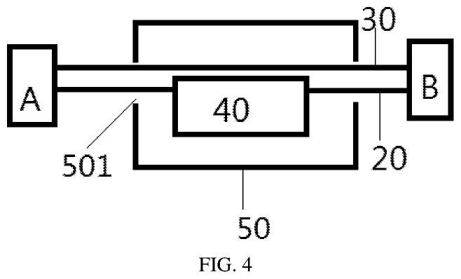

FIG. 4 shows a schematic structural diagram of a housing containing the starting module according to an embodiment of the present disclosure.

As shown in FIG. 4, the starting module 10 further includes a housing 50. The starting module 40 is received in housing 50, at least one through hole (two through holes shown in FIG. 4) is provided on the housing 50, and the first connection line 20 and/or the second connection line 30 are configured to pass through the at least one through hole 501. In the present disclosure, the through hole 501 is provided on the housing 50, and the first connection line 20 and/or the second connection line 30 pass through the through hole 501. The housing 50 can prevent the starting module 40 from being damaged.

It can be understood that the housing 50 can be tubular. The housing 50 receives the first electromagnet 401, the second electromagnet 402 and the electromagnetic coil 403, at least partially, specifically, the first contact C1 and the second contact C2 are located in the tube, and the second electromagnet 402 is attracted to be in contact with the first contact C1 and the second contact C2.

In an embodiment, the starting device 10 further includes a first connector and a second connector. The first connection line 20 is a positive connection line and the second connection line 30 is a negative connection line. The first connector is connected to the first connection line 20, and is used to connect to one of the positive and negative electrodes connected to the vehicle battery B of the vehicle. The second connector is connected to the second connection line 30, and is used to connect to the other of the positive and negative electrodes of the vehicle battery B of the vehicle.

In the present disclosure, the first connector and the second connector each can be in a shape of a clip for clamping the vehicle battery B of the vehicle.

The starting module 40 of the present disclosure can be turned on without the voltage provided by the vehicle battery B of the vehicle or the voltage provided by other external power sources. Therefore, when the vehicle is connected to the vehicle, the voltage of the starting power source A is directly provided to the vehicle to assist the vehicle to start, and the vehicle can be normally started by directly using the starting power source A and the starting device 10, which not only overcomes the problem that the relay or MOS tube need to be powered by the vehicle battery B of the vehicle before starting. Since the present disclosure uses the electromagnet and the electromagnetic coil, it overcomes the problems of large volume of the relay or MOS tube, which are prone to contact welding due to excessive starting current, bounce and abnormal operation, resulting in short life.

The present disclosure further provides a starting system of a vehicle, including the starting device 10 described in any of the embodiments and a starting power source A connected to the starting device 10.

The present disclosure further provides a vehicle, including the starting device 10 described in any of the embodiments.

The present disclosure further provides a vehicle, including the starting system of the vehicle battery B described in any of the above embodiments.

The above are only some embodiments of the present disclosure, and do not limit the scope of the present disclosure thereto. Under the inventive concept of the present disclosure, equivalent structural transformations made according to the description and drawings of the present disclosure, or direct/indirect application in other related technical fields are included in the scope of the present disclosure.

What is claimed is:

1. A starting device, comprising a first connection line, a second connection line and a starting module; wherein:
the first connecting line and the second connecting line are configured to transmit a current provided by a starting power source to provide a voltage of the starting power source to a vehicle;
the starting module is connected to at least one of the first connection line and the second connection line;
the starting module is turned on when the first connection line and the second connection line are not connected to a vehicle battery of the vehicle, and
the starting module is turned off, when the vehicle battery of the vehicle is charged and the first connection line and the second connection line are abnormally connected to the vehicle battery of the vehicle.

2. The starting device of claim 1, wherein the starting module is turned on when the first connection line and the second connection line are normally connected to the vehicle battery of the vehicle.

3. The starting device of claim 1, wherein the starting module includes a first electromagnet, a second electromagnet and an electromagnetic coil;
the first connection line includes a first portion and a second portion, and a first contact is provided on the first portion and a second contact is provided on the second portion;
the electromagnetic coil is fixedly sleeved on the first electromagnet, a first end of the electromagnetic coil is connected to the vehicle battery of the vehicle via the second portion of the first connection line, and a second end of the electromagnetic coil is connected to the second connection line; and
the first electromagnet and the second electromagnet are repelled by each other to be turned off when the vehicle battery of the vehicle is charged and the first connection line and the second connection line are abnormally connected to the vehicle battery of the vehicle.

4. The starting device of claim 3, wherein the first electromagnet is attracted to the second electromagnet to turn on the starting module when the first connection line and the second connection line are not connected to the vehicle battery of the vehicle, or
the first electromagnet is attracted to the second electromagnet to turn on the starting module and the voltage of the starting power source is provided to the vehicle when the first connection line and the second connection line are normally connected to the vehicle battery of the vehicle.

5. The starting device of claim 4, wherein the second electromagnet is attracted to contact with the first contact and the second contact, to turn on the starting module.

6. The starting device of claim 3, wherein the first electromagnet is an electromagnet, and the second electromagnet is a permanent magnet.

7. The starting device of claim 3, further comprising:
a housing;
wherein the starting module is received in housing, at least one through hole is provided on the housing, and the first connection line and/or the second connection line are configured to pass through the at least one through hole.

8. A starting system of a vehicle, comprising the starting device of claim 1 and a starting power source connected to the starting device.
